(19) United States
(12) Patent Application Publication
(10) Pub. No.: US 2002/0170073 A1
(43) Pub. Date: Nov. 14, 2002

(54) System and method for set top box channel state feedback

(76) Inventors: Douglas Miller, Seattle, WA (US); Keith Curtis, Bothell, WA (US)

Correspondence Address: SQUIRE, SANDERS & DEMPSEY L.L.P., 600 Hansen Way, Palo Alto, CA, 94304, US

(21) Appl. No.: 09/818,085

(22) Filed: Mar. 26, 2001

(51) Int. Cl. H04N 7/16

(52) U.S. Cl. 725/139; 725/151

(57) ABSTRACT

An apparatus for determining a channel state of a set top box, comprises: a sensing stage capable to detect light intensity from various positions on a display and generating output signals based on light intensity detected from each of the various positions; a comparison stage communicatively coupled to the sensing stage and capable to generate digital values by comparison of each generated output signals with a threshold value; and an interface communicatively coupled to the sensing stage and capable to generate a feedback signal based upon the digital values to indicate a channel state of the set top box.

### TECHNICAL FIELD

This disclosure relates generally to set top boxes for use in interactive television (“TV”) systems, and more particularly but not exclusively, to systems and methods for providing set top box channel state feedback to companion box devices or other devices that function with set top boxes.

### BACKGROUND

IR blasters, such as those used in DVRs, which receive video signals from separate devices, mimic infrared (“IR”) signals that are sent from remote control devices. DVRs may use IR blasters to change channels on a set top box (“STB”). For example, a DVR may be preset to record a channel at a certain time. Accordingly, the IR blaster of the DVR will send an IR signal (with code), mimicking the remote control device's IR signal, to the STB to change the STB channel to the channel to be recorded at the preset time.

However, for various reasons, IR blasters are not always effective at changing the STB channels. For example, an IR blaster may not be properly aligned with an IR receiver in the STB, and this misalignment may lead to the STB not detecting the command in the IR beam from the DVR or other companion box device. Additionally, a central processing unit (“CPU”) in the STB may not be fast enough to process an IR command to change a channel in an IR signal. Accordingly, if the IR blaster of the DVR sends a command to change the channel in the STB, the STB may not be able to change the channel, thereby leading to the incorrect channel being recorded. Further, there is no way for the DVR to know that the change signal command was not detected or not processed by the STB, and that, therefore, the IR command needs to be retransmitted to the STB.

Another possible problem is that a viewer may change the STB channel with a remote control, thereby conflicting with any channel select/change commands sent by the IR transmitter of the DVR. For example, a DVR may have sent a command to the STB to select a channel, and the STB responds to the command. However, the viewer may then send another, conflicting, channel select/change command to the STB, which the STB responds to by changing channels. Since the DVR will not be aware that the channel was subsequently changed by the command from the viewer, the DVR will not record the appropriate channel.

Accordingly, a new system and method is highly desirable to improve the functionality between a DVR and an STB and to overcome the above-mentioned deficiencies and disadvantages. A new system and method is also highly desirable to improve the functionality between an STB and a companion box that may function with the STB.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating an example of a system that can implement an embodiment of the invention.

FIG. 2 is a block diagram illustrating an example of some of the components in the set top box of FIG. 1.

FIG. 3 is a block diagram illustrating an example of some of the components in the companion box device of FIG. 1.

FIG. 4 is a block diagram illustrating an embodiment of the channel state feedback block of FIG. 1, along with a set top box and a companion box device.

FIG. 5 is a block diagram showing additional details of the channel state feedback block of FIG. 4.

FIG. 6 is a flowchart diagram illustrating an embodiment of a method for detecting a channel state of a set top box.

FIG. 7 is a block diagram illustrating another embodiment of the channel state feedback block of FIG. 1.

FIG. 8 is a block diagram showing additional details of the channel state feedback block of FIG. 7.

FIG. 9 is a block diagram showing the contents of the memory in the companion box device of FIG. 3.

FIG. 10 is a flowchart diagram illustrating another embodiment of a method for determining the channel state of a set top box.

### DETAILED DESCRIPTION OF THE ILLUSTRATED EMBODIMENTS

Embodiments of systems and methods for providing an STB channel state feedback are disclosed herein. As an overview, an embodiment of the invention provides a channel state feedback block that is communicatively coupled to a companion box device and a light emitting diode (“LED”) display of an STB. The feedback block includes light-sensing elements that measure the light intensity output of LED segments in the LED display. The feedback block then generates a feedback signal based on the measured light intensity of the LED segments and transmits the feedback signal to the companion box device for processing. Based on the feedback signal, the companion box device can determine the actual channel state of the set top box and can send additional command signals to the set top box to change the STB channel to the appropriate setting. In another separate distinct application, the feedback block may detect the light intensity from the STB LED display and generate a feedback signal to a DVR that functions with the STB.

In one embodiment, a central processing unit (CPU) (or another type of processor) in the companion box device executes a character recognition engine to process the feedback signal in order to determine the current channel state of the STB. The companion box device compares the current channel state with a desired channel state of the STB and can send command signals to properly change the channel state of the STB to the desired channel state. Also, if, for example, a user sends a command from an STB remote control device to change the STB channel state, the invention permits the companion box device to detect the new STB channel state. Thus, the companion box device will be able to automatically update its information on the STB channel state.

Accordingly, the invention provides a feedback block that advantageously prevents various problems that occur when a companion box device is operating with an associated STB. The present invention also advantageously maintains channel state synchronicity between the companion box device and the set top box, thus enabling a user to easily operate these devices in an interactive system.

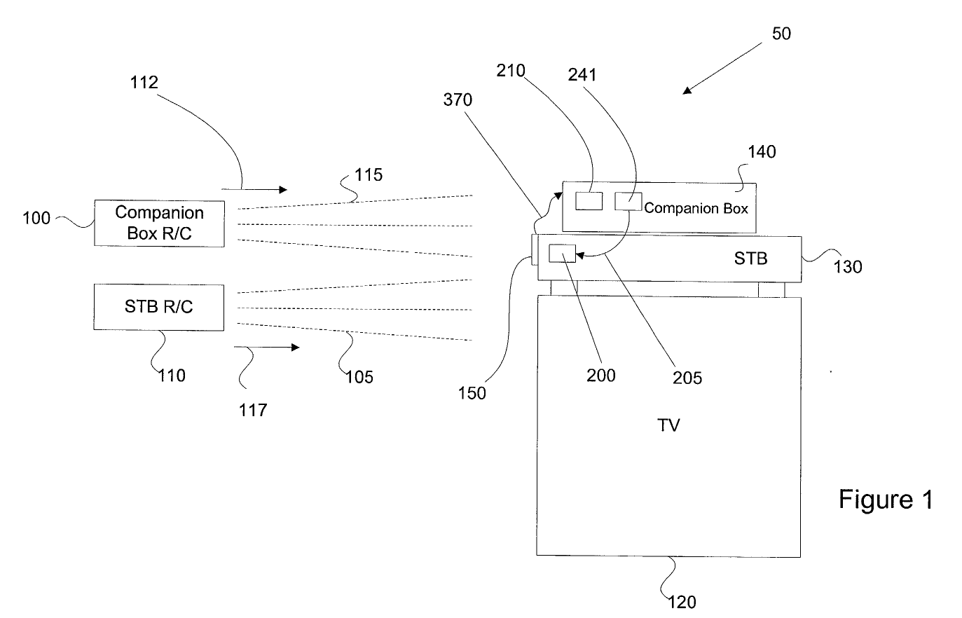

In the description herein, numerous specific details are provided, such as the description of system components in FIGS. 1 through 10, to provide a thorough understanding of embodiments of the invention. One skilled in the relevant art will recognize, however, that the invention can be practiced without one or more of the specific details, or with other methods, components, materials, parts, and the like. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

FIG. 1 is block diagram illustrating an example of a system 50 that can implement an embodiment of the invention. The system 50 comprises a set top box (STB) 130, a companion box device 140, and two remote control devices, namely, a companion box remote control (“companion box R/C”) 100 and an STB remote control (“STB R/C”) 110. The STB 130 is coupled to a television (TV) 120 and sends TV signals received from a cable network or other systems to the TV 120 for display. Companion box device 140 sends commands 205 via an IR transmitter 241 (e.g., IR blaster) to the STB 130 in order to control particular functions in the STB 130 such as the selection of the channel state (tuned channel) in the STB.

Companion box R/C 100 can send commands 112 via an IR beam 115 to permit the companion box device 140 to select or change the channel state of STB 130 or perform other functions in the STB 130. Companion box device 140 has an IR receiver 210 for receiving the commands 112 from companion box R/C 100.

R/C 110 can send commands 117 via IR beam 105 to permit certain functions in the STB 130 such as the selection of the channel state of STB 130. STB 130 has an IR receiver 200 for receiving commands 117 from STB R/C 110.

A channel state feedback block (device) 150 according to embodiments of the invention is also shown in FIG. 1. Feedback block 150 can detect the channel state of STB 130 and can provide to the companion box device 140 a feedback signal 370 indicating the channel state of STB 130. The companion box device 140 can use this feedback signal 370 to accurately detect the STB channel state and to make processing decisions based on the feedback signal 370. For example, based on the feedback signal 370, the companion box device 140 can determine the actual channel state of the STB 130 and can send additional command signals to the STB 130 to change the STB channel state to the appropriate setting, if necessary.

The feedback block 150 may be attached to STB 130 via, for example, Velcro®, adhesives, magnets, screws, fasteners, or other suitable coupling elements.

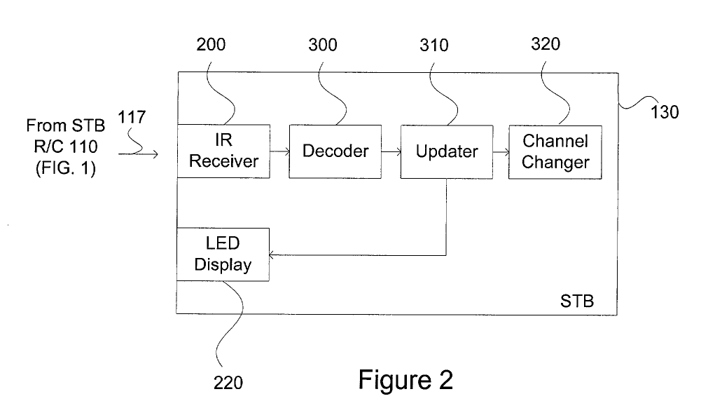

In another embodiment of channel state feedback block 150, an LED display (not shown) may be located on the feedback block 150 surface that does not interface with the STB 130. When the feedback block 150 is mounted with the STB 130, it may conceal the STB LED display 220 (FIG. 2) from the user's viewpoint. Therefore, the above-mentioned LED display on the feedback block 150 surface will permit the feedback block 150 to instead display the current STB 130 channel state.

FIG. 2 is a block diagram illustrating an example of some of the components in the STB 130 of FIG. 1. STB 130 includes the IR receiver 200; a decoder block 300; an updater block 310; a channel changer 320; and a light emitting diode (LED) display 220. IR receiver 200 receives the commands 117 from STB R/C 110 via IR beam 105. Decoder 300 decodes the commands 117 in IR beam 105. Assuming that a command 117 is for changing a currently tuned channel in the STB 130, the updater 310 then updates the channel state of LED display 220 to reflect the change in channel, while channel changer 320 changes the channel tuned in STB 130 and displayed on TV 120 in response to the command 117.

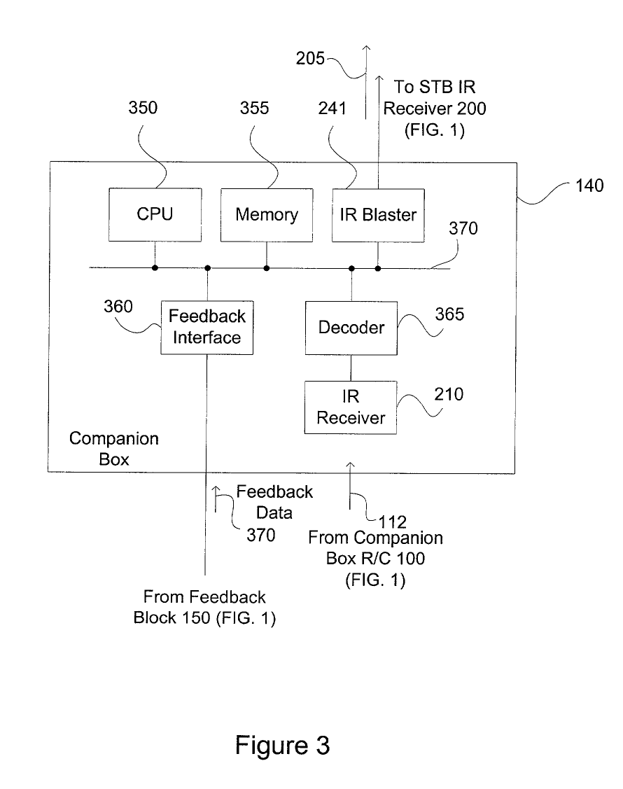

FIG. 3 is a block diagram illustrating an example of some of the components in the companion box device 140 of FIG. 1. Companion box device 140 may include, for example, the functionality of an Interactive Companion Set Top Box, as described in U.S. patent application Ser. No. ______, filed on Mar. 22, 2001, entitled “Interactive Companion Set Top Box,” by inventors Ted M. Tsuchida and James A. Billmaier, the disclosure of which is hereby incorporated by reference. Functions of the Interactive Companion Set Top Box may include Internet access, Video-on-Demand, an electronic programming guide, videoconferencing, and other functions.

Companion box device 140 comprises a CPU 350; a memory device 355; the IR transmitter 241; a feedback interface 360; and the IR receiver 210 coupled to a decoder 365. A bus 370 interconnects at least some of the above elements as shown in FIG. 3 to permit communications between these various elements. CPU 350 is configured to execute computer software instructions stored in memory device 355 and manage the operations of the companion box device 140. Memory device 355 may comprise a hard drive, random access memory (“RAM”), read only memory (“ROM”), or any other suitable memory device, or combination thereof. IR transmitter 241 mimics the IR beam 105 (FIG. 1) from STB R/C 110, thereby sending commands 205 to IR receiver 200 of STB 130. These commands 205 may, for example, cause STB 130 to change channels and update the channel state as displayed on LED display 220 (FIG. 2).

Feedback interface 360 receives digital feedback data 370 from feedback block 150 (FIG. 1) and feeds the data to software in memory 355 for processing, as will be discussed in further detail below. As also discussed below, the feedback data 370 are unique digital codes that are produced by the feedback block 150, with each unique digital code corresponding to a particular channel state shown in the STB LED display 220.

IR receiver 210 receives commands 112 via IR beam 115 from companion box R/C 100. For example, in one instance these commands 112 may include instructions to record a specific TV program at a specific time on a specific channel. Decoder 365 decodes these instructions from commands 112 and forwards the decoded instructions to an appropriate software in memory 355 for processing.

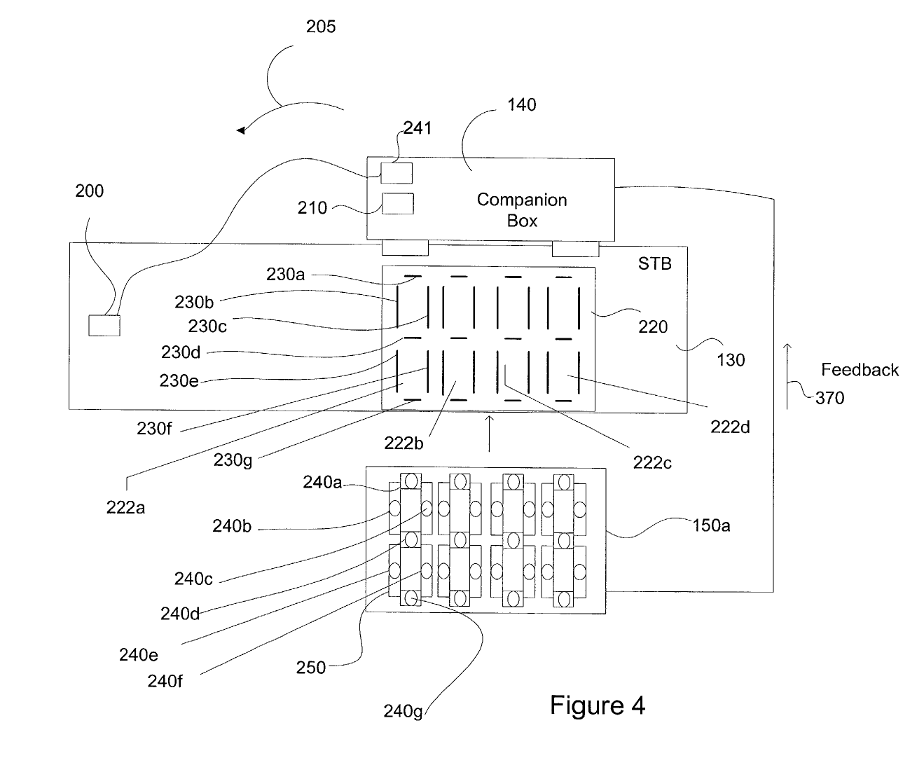

FIG. 4 is a block diagram illustrating an embodiment of the channel state feedback block 150 of FIG. 1, along with the STB 130 and companion box device 140. The STB 130 includes an LED display 220 featuring, for example, a four-digit display. The LED display is typically on the front panel of a set top box. The four digits are represented by reference numerals 222a, 222b, 222c, and 222d. However, the number of digits in the LED display 220 may vary. Each digit 222 typically comprises seven (7) light emitting diode (LED) segments. For example, the digit 222a is formed by LED segments 230a-230g. Thus, there are about twenty-eight (7×4=28) LED segments in the display 220.

In the embodiment shown in FIG. 4, channel state feedback block 150a comprises a sensing stage including twenty-eight (28) light sensing elements 240 that match the twenty-eight (28) LED segments in the display 220. In alternative embodiments, the feedback block 150a may comprise a different number of light sensing elements 240. For example, the feedback block 150a may comprise about thirty-five (35) light sensing elements 240 if there are about thirty-five (35) LED segments in the display 220. The light sensing elements 240 may be, for example, photodiodes, phototransistors, or other suitable light sensing elements or a combination of different types of light sensing elements.

The channel state feedback block 150a is attached to the STB 130 so that the feedback block 150a substantially covers the LED display 220 and so that the light sensing elements 240 substantially line up with the LED segments 230. For example, the sensing elements 240a, 240b, 240c, 240d, 240e, 240f, and 240g substantially line up with (and/or are associated with) LED segments 230a, 230b, 230c, 230d, 230e, 230f, and 230g, respectively. In one embodiment, each of the light sensing elements 240 is surrounded by a respective shield 250 that attenuates light from all but one unique LED. Each shield 250 may be made of plastic or other suitable elements. As discussed below in more detail, a light-sensing element 240 generates an output analog signal responsive to an intensity of an LED 230 associated with that light-sensing element 240. The values of the output analog signals of the light sensing elements are processed by elements in the feedback block 150a, and the feedback block 150a generates an appropriate feedback signal 370 to the companion box device 140. The feedback signal 370 indicates the channel state of STB 130 and permits the companion box device 140 to accurately detect the tuned channel or any changes in the tuned channel of STB 130.

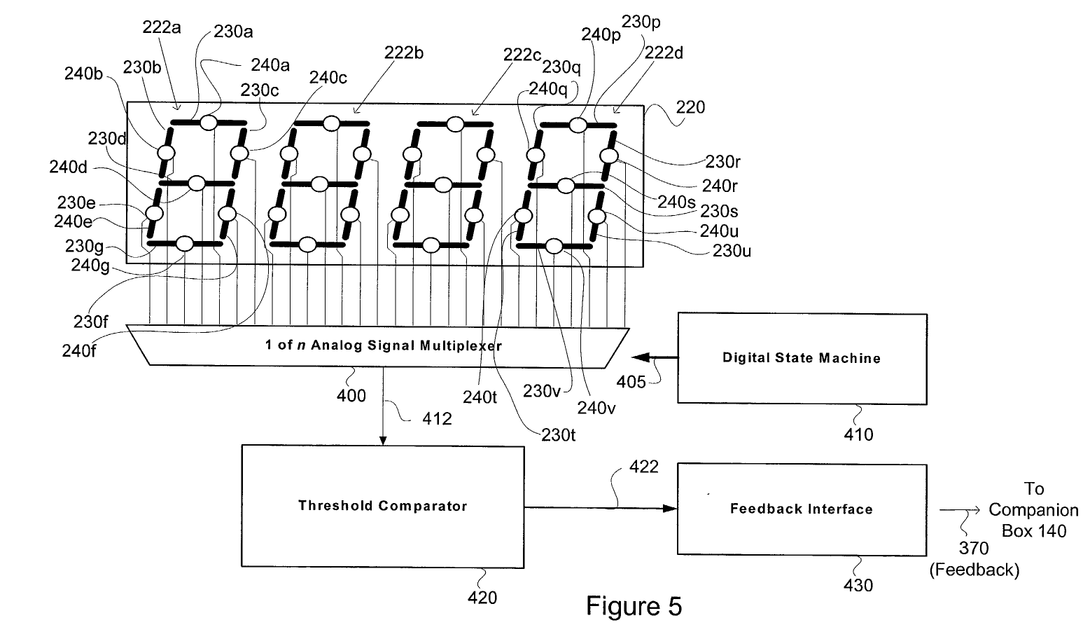

FIG. 5 is a block diagram showing additional details of the channel state feedback block 150a, which is coupled to LED display 220. Feedback block 150a comprises the light-sensing elements 240, a multiplexer (or switch) 400, a digital state machine 410, a threshold comparator (comparison stage) 420, and a feedback interface 430. As mentioned above, a light-sensing element 240 is positioned to detect the light intensity of an LED 230 associated with that particular light-sensing element 240. In one embodiment, the digital state machine 410 may use a standard software algorithm that generates commands 405 to permit the multiplexer 400 to pass each light-sensing element 240 output to the threshold comparator 420 in a round robin manner. In another embodiment, the digital state machine 410 is a counter that receives a clock input and generates control signals for controlling the multiplexer 400. Thus, the signal 412 is an analog output of a light-sensing element 240 that has been passed through by multiplexer 400. Threshold comparator 420 compares each analog signal 412 with a threshold value and produces digital outputs 422 based upon the comparison function performed for each analog signal 412. For example, the digital output 412 will have a logic zero value for a corresponding LED segment 230 that is OFF. The digital output 412 will have a logic one value for a corresponding LED segment 230 that is ON. The feedback interface 430 receives a series of comparator 420 decisions and based on these decisions, the feedback interface 430 generates a feedback signal 370 that is transmitted to the feedback interface 360 (FIG. 3) of companion box device 140. The feedback signal 370 has a value indicating the channel being displayed on LED display 220 of STB 130. In one embodiment, the feedback signal 370 is serial digital bit-stream.

The components in the state channel feedback block 150a may be implemented discretely. Alternatively, the feedback block 150a components may be implemented as an Application Specific Integrated Circuit (“ASIC”), Field Programmable Gate Array (“FPGA”), or other suitable devices.

Reference is now made to Tables 1 and 2 to describe an example of the operation of the elements shown in FIG. 5.

TABLE 1
Display 220 showing a channel value
of “1” during time period T1

| | | Comparator 420 |
|---|---|---|
| | | output values |
| Detected states of | Light sensing elements | corresponding to |
| LED segments 230 | 240 output values at | light sensing elements |
| at time period T1 | time period T1 | 240 output values |
| For digit 222a: | Light sensing elements | All comparator 420 |
| all LED segments | 240a to 240g output | output values are logic |
| 230a to 230g are | values are all zero | zero |
| all OFF | | |
| For digit 222b: | All light sensing | All comparator 420 |
| all LED segments | elements 240 that | output values are logic |
| are OFF | detects LED segments in | zero |
| | digit 222b are zero in | |
| | output values | |
| For digit 222c: | All light sensing | All comparator 420 |
| all LED segments | elements 240 that | output values are logic |
| are OFF | detects LED segments in | zero |
| | digit 222c are zero in | |
| | output values | |
| For digit 222d: | | |
| LED segment | Light sensing element | Comparator 420 |
| 230p = OFF | 240p output = zero | output = logic zero |
| LED segment | Light sensing element | Comparator 420 |
| 230q = OFF | 240q output = zero | output = logic zero |
| LED segment | Light sensing element | Comparator 420 |
| 230r = ON | 240r output = high | output = logic one |
| LED segment | Light sensing element | Comparator 420 |
| 230s = OFF | 240s output = zero | output = logic zero |
| LED segment | Light sensing element | Comparator 420 |
| 230t = OFF | 240t output = zero | output = logic zero |
| LED segment | Light sensing element | Comparator 420 |
| 230u = ON | 240u output = high | output = logic one |
| LED segment | Light sensing element | Comparator 420 |
| 230v = OFF | 240v output = zero | output = logic zero |

Table 1 shows various values when the STB channel state on LED display 220 shows a tuned channel “1” during a current time period T1. Column 1 of Table 1 shows the LED segments 230 states in display 220 during the current time period T1. Column 2 shows the light sensing elements 240 output values based on the detected LED segments 230 states. Column 3 shows the comparator 420 output values based on the light sensing elements 240 output values. The values in column 3 are typically buffered in feedback interface 430 and are transmitted to the companion box device 140 as feedback signal 370 that is processed by the companion box device 140 to determine the STB channel state.

TABLE 2
Display 220 showing a value
of “8” during time period T2

| | | Comparator 420 |
|---|---|---|
| | | output values |
| Detected states of | Light sensing elements | corresponding to |
| LED segments 230 | 240 output values at | light sensing elements |
| at time period T2 | time period T2 | 240 output values |
| For digit 222a: | Light sensing elements | All comparator 420 |
| all LED segments | 240a to 240g output | output values are |
| 230a to 230g are | values are all zero | logic zero |
| all OFF | | |
| For digit 222b: | All light sensing elements | All comparator 420 |
| all LED segments | 240 that detects LED | output values are logic |
| are OFF | segments in digit 222b are | zero |
| | zero in output values | |
| For digit | All light sensing elements | All comparator 420 |
| 222c: all LED | 240 that detects LED | output values are logic |
| segments are | segments in digit 222c are | zero |
| OFF | zero in output values | |
| For digit 222d: | | |
| LED segment | Light sensing element | Comparator 420 |
| 230p = ON | 240p output = high | output = logic one |
| LED segment | Light sensing element | Comparator 420 |
| 230g = ON | 240q output = high | output = logic one |
| LED segment | Light sensing element | Comparator 420 |
| 230r = ON | 240r output = high | output = logic one |
| LED segment | Light sensing element | Comparator 420 |
| 230s = ON | 240s output = high | output = logic one |
| LED segment | Light sensing element | Comparator 420 |
| 230t = ON | 240t output = high | output = logic one |
| LED segment | Light sensing element | Comparator 420 |
| 230u = ON | 240u output = high | output = logic one |
| LED segment | Light sensing element | Comparator 420 |
| 230v = ON | 240v output = high | output = logic one |

Table 2 shows various values when the STB channel state on LED display 220 is changed to a tuned channel “8” during a subsequent time period T2. Accordingly, the new values in column 3 of Table 2 are transmitted to the companion box device 140 as feedback signal 370.

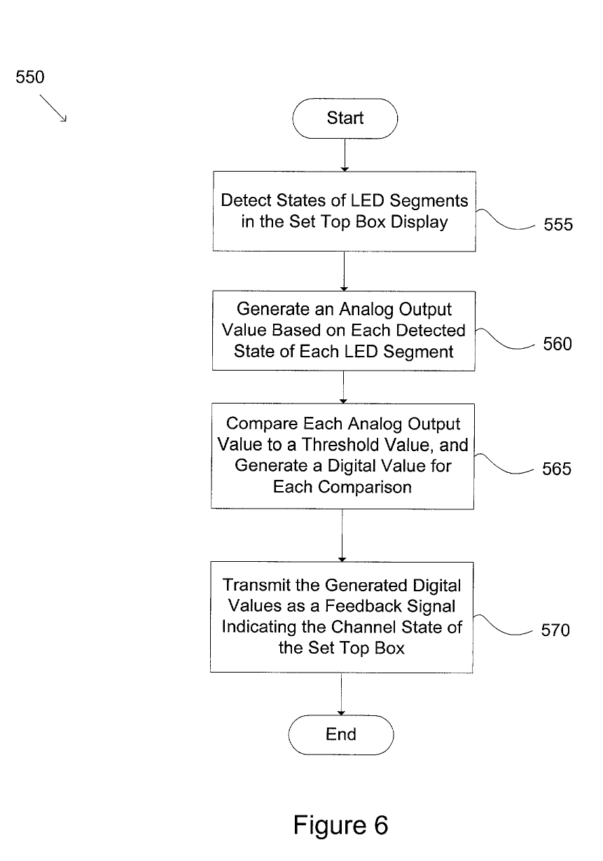

FIG. 6 is a flowchart diagram illustrating an embodiment of a method 550 for detecting a channel state of a set top box. The states of LED segments in a set top box display are first detected (555). An analog output value is generated (560) based on each detected state of each LED segment. For example, each LED segment 230 is detected by an associated light sensing device 240 as shown in FIG. 5, and each light sensing device 240 will output an analog output value 412 based on the detected state of an associated LED segment 230. Each analog output value is then compared (565) with a threshold value, and a digital value is generated for each comparison. For example, the multiplexer 400 will pass through each analog output value 412, and the comparator 420 compares each analog output value 412 with a threshold value. The generated digital values are then transmitted (570) as a feedback signal indicating the channel state of the set top box. For example, the feedback interface 430 buffers the generated digital values 422 and transmits the digital values to the companion box device 140 to indicate the channel state of the set top box 130.

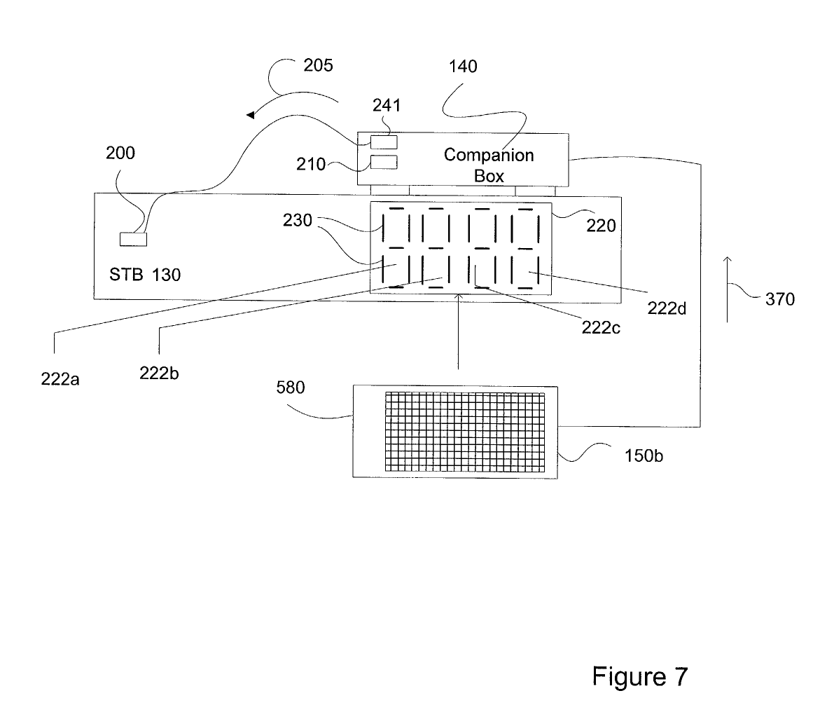

FIG. 7 is a block diagram illustrating another embodiment of the channel state feedback block 150 of FIG. 1, along with the STB 130 and companion box device 140. Feedback block 150b comprises a light sensing elements array 580 for detecting the states of LED segments 230 in the STB LED display 220. In one embodiment, array 580 includes 32 by 16 individual light sensing elements, which may be photodiodes, phototransistors, or other suitable light sensing elements or a combination of different types of light sensing elements. Feedback block 150b may be coupled to STB 130 as similarly described above for feedback block 150a. However, there is no need to align feedback block 150b with the individual LED segments 230 of LED display 220 as long as the entire LED display 220 is substantially covered by feedback block 150b.

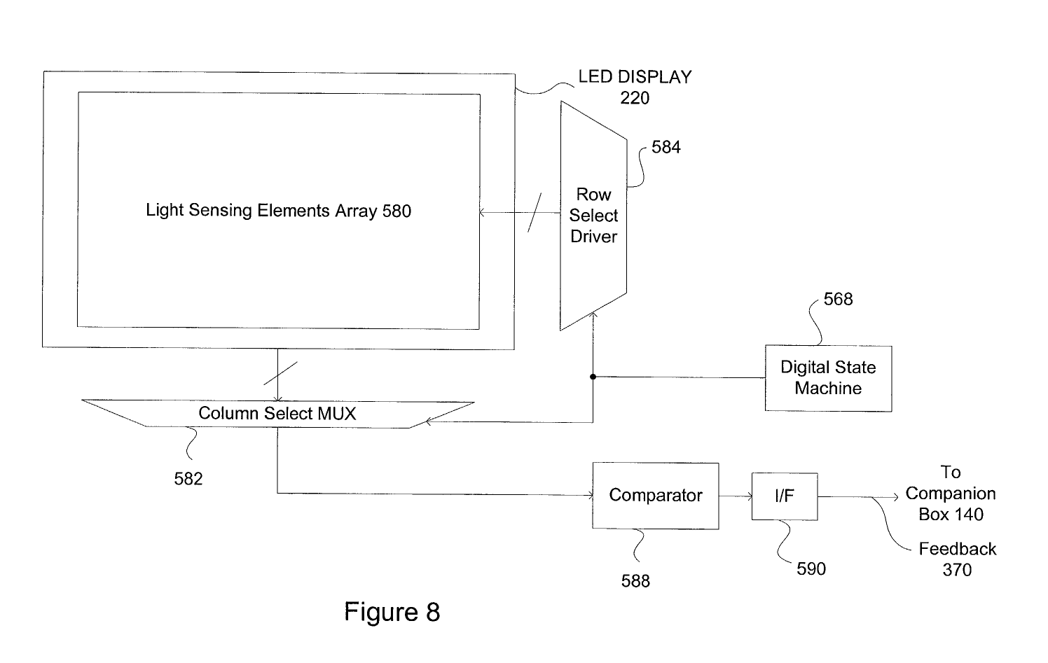

FIG. 8 is a block diagram showing additional details of the channel state feedback block of FIG. 7. A row select driver 584 and multiplexer 582 are configured to pass through the analog output signals of the light sensing elements in the array 580. A digital state machine 586 is used to control the driver 584 and multiplexer 582 to select, one at a time, the analog output signal of each photodiode in the array 580. A comparator (comparison stage) 588 compares the analog output signals (which are selected by multiplexer 582 and driver 584) with a threshold value and generates digital signals based on the comparisons. The digital signals are buffered by an interface (I/F) 590 and transmitted as a feedback signal 370 to the companion box device 140. As described below, the feedback signal 370 may then be processed in the companion box device 140 to determine the channel state of the set top box 130.

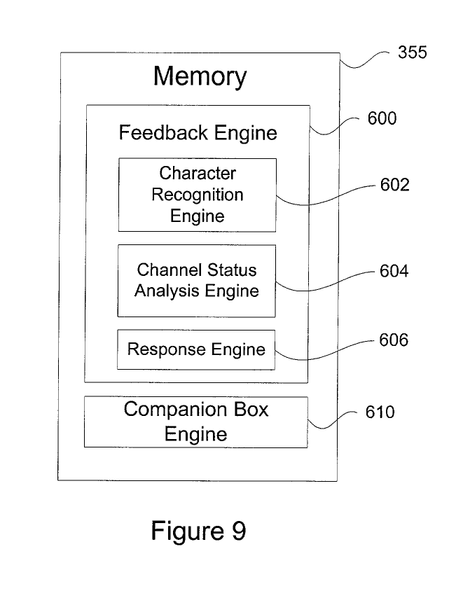

FIG. 9 is a block diagram showing contents of the memory 355 of the companion box device 140 (FIG. 1). Memory 355 includes a feedback engine 600 and a companion box engine 610, with both engines 600 and 610 capable of being executed by CPU 350 (FIG. 3). Feedback engine 600 includes a character recognition engine 602, a channel state (channel status) analysis engine 604 and a response engine 606. Character recognition engine 602 receives digital data from feedback interface 360 (FIG. 3) and uses a suitable character recognition algorithm to determine the channel being displayed on LED display 220. In another embodiment, the engine 602 compares the values of the feedback signal 370 with values in a look-up table (e.g., in memory) to determine the channel state of the STB 130. Channel state analysis engine 604 compares the measured channel state on LED display 220 with the channel state desired by the companion box device 140. If there is a discrepancy between the measured channel state and the desired channel state, then response engine 606 may command IR transmitter 241 (FIG. 3) to send a command 205 via an IR beam to IR receiver 200 of STB 130 to properly change the STB channel to the desired channel state.

Companion box engine 610 performs particular instructions depending on the functionality of the companion box device 140. For example, companion box engine 610 may include scheduling, recording, and viewing engines to record TV broadcasts and view recorded broadcasts. Other functions may also be performed by the companion box engine 610. For example, companion box device 140 may include functions as described in U.S. patent application Ser. No. ______, filed on Mar. 22, 2001, and entitled “Interactive Companion Set Top Box,” by inventors Ted M. Tsuchida and James A. Billmaier, the disclosure of which is hereby incorporated by reference. Therefore, companion box engine 610 may be able to execute functions including Internet access, Video-on-Demand, an electronic programming guide, videoconferencing, and other functions.

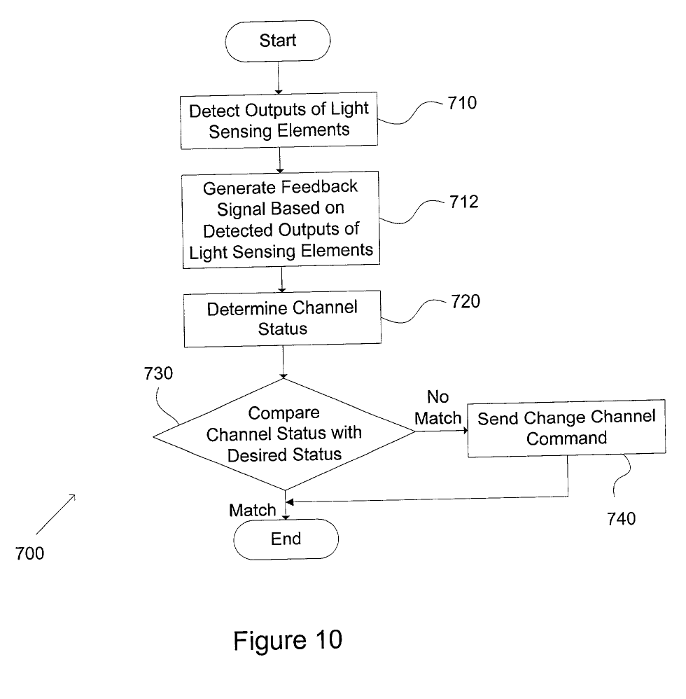

FIG. 10 is a flowchart showing another embodiment of a method 700 for determining the channel state of set top box 130. Method 700 typically runs continuously to measure the STB channel state. The output values of light-sensing elements are detected (710) where the light sensing elements detect the state of light emitting devices on a set top box display. Based on the detected states, a feedback signal is then generated (712). The channel state is determined (720) based on the feedback signal. In one embodiment, a character recognition engine 602 is used to make the determination (720). The measured channel state is then compared (730) with the channel state desired by the companion box device. In one embodiment, the comparison (730) is performed by the channel state analysis engine 604. If the measured channel state matches the desired channel state, then the method 700 ends. If there is no match, then a command may be sent (740) from the companion box device to the set top box to change the set top box channel to the desired channel state. In one embodiment, a response engine 606 may command an IR transmitter 241 to send the change channel command to the IR receiver 200 of STB 130. The method 700 then ends.

Other variations and modifications of the above-described embodiments and methods are possible in light of the foregoing teaching. For example, feedback engine 600 may be implemented in hardware instead of in software. Further, components of this invention may be implemented using a programmed general-purpose digital computer, using application specific integrated circuits, or using a network of interconnected components and circuits. Connections may be wired, wireless, modem, and the like.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for determining a channel state of a set top box, the apparatus comprising:
a sensing stage capable to detect light intensity from various positions on a display and generating output signals based on light intensity detected from each of the various positions;
a comparison stage communicatively coupled to the sensing stage and capable to generate digital values by comparison of each generated output signals with a threshold value; and
an interface communicatively coupled to the sensing stage and capable to generate a feedback signal based upon the digital values to indicate a channel state of the set top box.

2. The apparatus of claim 1 wherein the feedback signal is transmitted to a companion box device for processing, thereby permitting the companion box device to detect the channel state of the set top box.

3. The apparatus of claim 1 wherein the sensing stage comprises a plurality of light sensing devices, each of the light sensing devices capable to detect light intensity at a corresponding position on the display.

4. The apparatus of claim 1 wherein the sensing stage comprises an array of light sensing devices capable to detect light intensity at the various positions on the display.

5. An apparatus for detecting a channel state of a set top box, the apparatus comprising:
a sensing stage capable to sense output light from a plurality of light-sensing elements in a display of a set top box;
an engine capable to determine a channel state of the display based on the output;
a channel state analysis engine capable to compare the determined channel state with a desired channel state; and
a response engine capable to send a change channel command to the set top box if the determined channel state does not match the desired channel state.

6. A method of determining a channel state of a set top box, the method comprising:
detecting states of light emitting devices in a display of a set top box;
generating an analog value based on each detected state;
comparing each analog value with a threshold value and generating a digital value for each compared analog value; and
transmitting to a companion box device a bit stream having the generated digital values to permit the companion box device to determine a channel state of the set top box.

7. A method of determining a channel state of a set top box, the method comprising:
detecting states of light emitting devices in a display of a set top box;
generating a feedback signal based on the detected states;
determining a channel state of the set top box based on the feedback signal; and
comparing the determined channel state with a desired channel state.

8. A set top box channel state system, comprising:
a device including a plurality of light-sensing elements communicatively coupled to a display of a set top box, the display including a plurality of light emitting devices; and
a companion box device communicatively coupled to the light-sensing elements, the companion box device including
an infrared blaster capable to send commands via an IR beam to the set top box,
a character recognition engine capable to determine set top box channel state as displayed on the display based on the output of the light-sensing elements,
a channel state analysis engine communicatively coupled to the character recognition engine and capable to determine if the channel state matches a desired channel state, and
a response engine communicatively coupled to the analysis engine and the IR blaster and capable to command the IR blaster to send a change channel command via IR beam to the set top box if the channel state does not match the desired channel state.

9. The set top box channel state system of claim 8, wherein the plurality of light-sensing elements is equal in number to the plurality of light emitting devices in the display.

10. The set top box channel state system of claim 8, wherein the light-sensing elements are arranged in an array.

11. The set top box channel state system of claim 10, wherein the array includes 32 by 16 light-sensing elements.

12. The set top box channel state system of claim 8, wherein the device includes a second display configured to display the set top box channel state.

13. The set top box channel state system of claim 8, wherein the light-sensing elements include photodiodes.

14. A method of detecting a channel state of a set top box, the method comprising:
sampling output from a plurality of light-sensing elements coupled to a display of a set top box;
determining a channel state of the display based on the output;
comparing the determined channel state with a desired channel state; and
sending a change channel command to the set top box if the determined channel state does not match the desired channel state.

15. The method of claim 14, wherein the determining the channel state includes using character recognition software.

16. The method of claim 14, wherein the determining the channel state includes comparing the output with values in a look-up table.

17. The method of claim 14, wherein the light-sensing elements are photodiodes.

18. The method of claim of claim 14, wherein the plurality of light-sensing elements is equal in number to a plurality of light-emitting devices in the display.

19. The method of claim 14, wherein the plurality of light-sensing elements are arranged in an array.

20. The method of claim 19, wherein the array includes 32 by 16 light-sensing elements.

21. The method of claim 14, further comprising displaying the determined channel state on a second display.

22. A machine-readable medium having stored thereon instructions to:
sample output from a plurality of light-sensing elements coupled to a display of a set top box;
determine a channel state of the display based on the output;
compare the determined channel state with a desired channel state; and
send a change channel command to the set top box if the determined channel state does not match the desired channel state.

23. The machine-readable medium of claim 22, wherein the determining the channel state includes using character recognition software.

24. The machine-readable medium of claim 22, wherein the determining the channel state includes comparing the output with values in a look-up table.

25. The machine-readable medium of claim 22, further comprising an instruction to display the determined channel state on a second display.

26. A system for detecting a channel state of a set top box, the method comprising:
means for sampling output from a plurality of light-sensing elements coupled to a display of a set top box;
means for determining a channel state of the display based on the output;
means for comparing the determined channel state with a desired channel state; and
means for sending a change channel command to the set top box if the determined channel state does not match the desired channel state.
